(19) United States
(12) Patent Application Publication
(10) Pub. No.: US 2009/0150938 A1
(43) Pub. Date: Jun. 11, 2009

(54) Unifying User Interface for a Set-Top Box

(75) Inventor: Paul Clancy, Duluth, GA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/954,169

(22) Filed: Dec. 11, 2007

(51) Int. Cl. H04N 5/782

(52) U.S. Cl. 725/47

(57) ABSTRACT

An illustrative user interface for a set-top box includes a set-top box having a variety of functions available for selection by a user; and at least one pseudo channel corresponding to at least one of said functions rather than a channel of television programming. Selection of the pseudo channel by a channel identifier, as if it were a channel of programming to be tuned, initiates the corresponding function or functions of the set-top box.

### BACKGROUND

A set-top box is a device that connects a television or monitor, typically in a home entertainment system, with an external signal source. The set-top box is used to manage the content from the external signal source, for example, by tuning a particular channel from a cable or satellite television signal for use by the home entertainment system. The external signal source may include, for example, an Ethernet cable, a satellite dish, a coaxial cable, a telephone line (including DSL connections), broadband over power line, or a terrestrial television antenna. Content, in this context, could mean any or all of video, audio, or audiovisual content, including Internet web pages, interactive computer games, or other possibilities.

In conventional applications, the primary functionality of a set-top box is to display and manipulate a large number of television channels. Users are familiar with the straightforward process of using a channel based interface to find and select desired programming. Users typically view only a small subset of the available channels and may remember frequently viewed channels and directly enter the corresponding channel number to view the desired programming. If the user cannot remember the channel number, he or she can find the channel via a guide or by simply channel changing until the desired channel is found.

Set-top boxes may have more advanced functionality. This advanced functionality can include additional software applications, higher level internal functions, and interconnectivity with external networks and devices. In some instances, the set-top box serves as an access point for the user to an interactive network that makes available Internet content, video-on-demand, pay-per-view and other services. By way of example and not limitation, advanced functionality in a set-top box may include the ability to access and playback MPEG-1 Audio Layer 3 (MP3) files and play lists, recorded video or photo slide shows; interact over a video phone; view a front door security camera; play a computer game; browse attached network storage; access a web browser or access an e-mail application.

Consequently, there is a clear need for a unified user interface that provides a simple and familiar process for accessing the set-top box functions that a user most frequently utilizes.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is an illustrative diagram of interconnectivity options that may be available for a set-top box, according to principles described herein.

FIG. 2 is an illustrative diagram of advanced functions that may be available through a set-top box, according to principles described herein.

FIGS. 3A-3C illustrate one embodiment of a menu driven interface for selecting a specific set-top box function, according to principles described herein.

FIG. 4 is an illustrative diagram of one embodiment of a hierarchal tabbed interface for selecting specific set-top box functions, according to principles described herein.

FIG. 5 is an illustrative diagram of one embodiment of a menu configured to associate a specific set-top box function with a pseudo channel, according to principles described herein.

FIG. 6 is an illustrative diagram of one embodiment of a menu configured to associate a specific set-top box function with a pseudo channel, according to principles described herein.

FIG. 7 is an illustrative diagram of one embodiment of a remote control with a specialized button configured to associate a specific function with a pseudo channel, according to principles described herein.

FIG. 8 is an illustrative diagram of one embodiment of a program guide showing the relationship between pseudo channels and set-top box functionality, according to principles described herein.

FIG. 9 is an illustrative diagram of one embodiment of a program guide showing the relationship between pseudo channels and set-top box functionality, according to principles described herein.

FIG. 10 is an illustrative flow chart showing one embodiment of a method of associating and activating set-top box functions with a pseudo channel, according to principles described herein.

FIG. 11 is an illustrative flow chart showing one embodiment of a method of associating and activating set-top box functions with a pseudo channel, according to principles described herein.

FIG. 12 is an illustrative block diagram of a set-top box, according to principles described herein.

FIG. 13 is an illustrative flow chart showing one embodiment of a method of activating set-top box functions with a pseudo channel, according to principles described herein.

Throughout the drawings, identical reference numbers designate similar, but not necessarily identical, elements.

### DETAILED DESCRIPTION

The advanced functionality of a set-top box is often more difficult to access than merely selecting a numbered channel of television programming. As further described below, these advanced functionalities are typically accessed through menu driven user interfaces. Such menus typically display all the options available to the user at a specific location within a system of menus. Consequently, menus can be useful when becoming familiar with a new system. However, for experienced users who desire to access specific functionality quickly, the time consuming and repetitive process of navigating through multiple menus can be both laborious and annoying. By way of example, to access a specific function such as a MP3 list stored on an external drive, the user may have to work through four or more sequential menus to access the audio application and begin playing a desired set of songs.

To facilitate a user's understanding and operation of a set-top box, the present specification describes a unifying user interface that can be created by using channels as a means of selecting and/or activating the various functionality of a set-top box. To create this interface, commonly used functions are assigned a channel number, creating a pseudo channel. Selecting a commonly used function would then be as simple and familiar as entering the channel number associated with that function.

Throughout the specification and appended claims, the term “set-top box” is used to describe any hardware or software device that is configured to manage audio, video or audiovisual content from one or more sources for use with a television set, monitor, computer or other content playback device. Typically, a set-top box will be capable of interconnectivity with external devices and/or networks. In a basic embodiment, a set-top box will manipulate and display a plurality of channels of audiovisual programming received, for example, from a cable or satellite television network. However, many set-top box embodiments will have functionality that extends beyond basic channel management as described herein.

As used herein and in the appended claims, the term “pseudo channel” will refer to a channel number that has been assigned to a specific function or series of commands of a set-top box, where the box executes that functionality or commands in response to entry of the pseudo channel number.

By allowing advanced features to be accessed and manipulated in the same manner as other television channels and programming, a unified user interface is provided that greatly simplifies access to the full range of advanced set-top box functionality as compared with a purely menu-driven interface for accessing the same functionality. Consequently, this unified user interface leverages the traditional strengths of the set-top box as a device for manipulating and displaying channels. Further, this unified user interface is a more efficient and convenient method for accessing commonly used set-top box functions.

A detailed description and illustrative examples of this unified user interface will now be provided. In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

Set-top box manufacturers typically design and construct the set-top box components as well as the firmware that controls the basic functionality within the set-top box. Service providers then purchase the set-top box and load an application software package that may include a graphical user interface and other high level programming. The hardware, firmware, and software work together to create various set-top box functionalities. For example, the set-top box may receive a command from a remote control unit which is then interpreted and formatted by the firmware. The firmware then passes the command to the service provider software package. The software package may respond by instructing the firmware to access a specific location in the set-top box memory, change data sources, display specific data, or some other function.

As indicated above, set-top boxes are becoming increasingly capable, with escalating levels of functionality. In many instances, set-top boxes have a built-in digital video recorder that can record data from a variety of sources and later retrieve data for playback. This allows a variety of high level functions including time shifting, pause, rewind, and replay of programming. The viewer can also use a built-in guide to view available channels, schedule recordings, and access programs that have been previously recorded on the set-top box hard drive.

Many set-top boxes have dual tuners which allow the user to simultaneously view a first television program while recording a second program, or while watching the second program as a picture-in-picture. Set-top boxes are also expanding their functionality to include music, photographs, Internet and Web functionality, and interconnectivity to external devices.

For example, the Motorola DCH6416 set-top box has a wide range of functionality and interconnectivity. The Motorola DCH6416 contains a variety of ports such as Universal Serial Bus (USB) 2.0 ports, cable, M-cards, serial ports, S-Video, Audio and Video inputs, High Definition Multimedia Interface (HDMI) TV connectors, external serial disk interconnections, Ethernet network connections, and IEEE-1394 connections.

Each of these ports can connect a variety of compatible devices to the set-top box, allowing the content and functionality of the connected device to be used by the set-top box. For example, USB 2.0 devices can range from a mouse to a large capacity external hard drive. Additionally, USB connections are common place for transferring data to and from cameras, video cameras, personal digital assistants, computers of all types, printers/faxes, and other devices.

The IEEE 1394 interface (also known as Firewire and i.Link) is a serial bus interface standard that offers high speed communications and real time data services. IEEE 1394 has been adopted as the High Definition Audio-Video Network Alliance (HANA) standard connection interface for audio/visual (A/V) component communication and control. This interface is available in almost all modern digital camcorders and laptop computers.

The HDMI interface supports any television or personal computer video format, including standard, enhanced, or high definition video, plus multi-channel digital audio on a single cable.

Additionally, set-top boxes have increasingly significant computational ability. For example, a Motorola DCH6416 set-top box supports video scaling (Picture-in-Graphics), picture-in-picture, graphics acceleration, motion-compensating temporal filters, de-interlacing, and other capabilities.

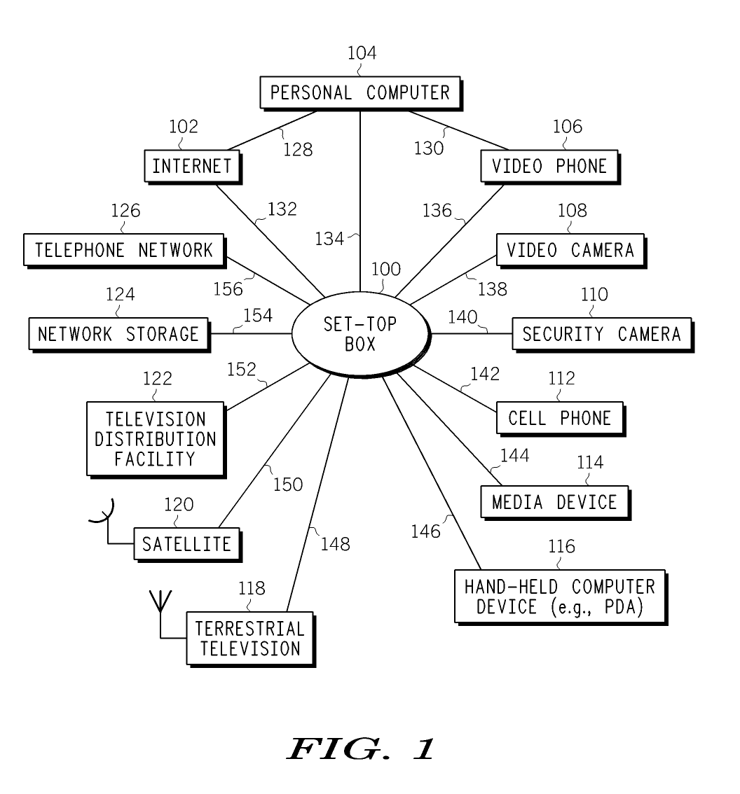

As set-top box technology advances, the amount of interconnectivity and functionality of the set-top box increases. FIG. 1 illustrates some of the interconnections that could be made between a set-top box (100) and other electronic elements. The set-top box (100) traditionally has received data primarily from television distribution facilities (122) including cable networks, satellite television providers (120) and from terrestrial television broadcasts (118). The interconnectivity (152) between the set-top box (100) and the television distribution facilities (122) can occur over a variety of connections such as coaxial cable or electromagnetic transmission. The connection (150) between satellite television providers (120) is typically through a dish/satellite receiver that is located in proximity and connected to the set-top box (100). In some circumstances, the set-top box (100) can act as both a receiver and a decoder for satellite transmissions. Terrestrial television broadcasts (118) are typically received via an antenna that can be connected to a set-top box (100).

Set-top boxes are also increasingly capable of connecting to the Internet (102), telephone networks (126) and other networked storage (124). Set-top boxes often include an Ethernet port which provides a wired connection (132, 154) between the set-top box (100) and the Internet (102) and/or other networked storage (124). The set-top box (100) can download, upload, access, and display information from Internet websites and data bases. For example, in some cases the set-top box is configured to download a program schedule by connecting to an Internet database. This schedule is displayed to inform the user of current or upcoming programs that the user may desire to record or view.

In many cases, two or more alternative connection types can be used to connect to external devices or networks. For example, the set-top box can be connected (154) to a variety of storage devices (124) by an Ethernet connection, wireless connection, FireWire or through a USB port. The external storage device can store video, audio, or other data.

Additionally, there are a variety of personal and household electronics that could be connected to the set-top box (100). For example, a personal computer (104), a video phone (106), a camcorder (108), a security camera (110), a cell phone (112), hand held computing device such as a personal digital assistant (PDA) (116), or another media device (114) could be connected to the set-top box by various means. The connection could consist of a USB connection, an infrared wireless transmission, a radio frequency wireless transmission, video feed, Ethernet connection, or other type of connection.

Additionally, the components that can be connected to the set-top box could also be interconnected as illustrated by the connection (128) between the personal computer (104) and the Internet (102), or the connection (130) between the personal computer (104) and the video phone (106). Other interconnections between the components could be present, but are not shown.

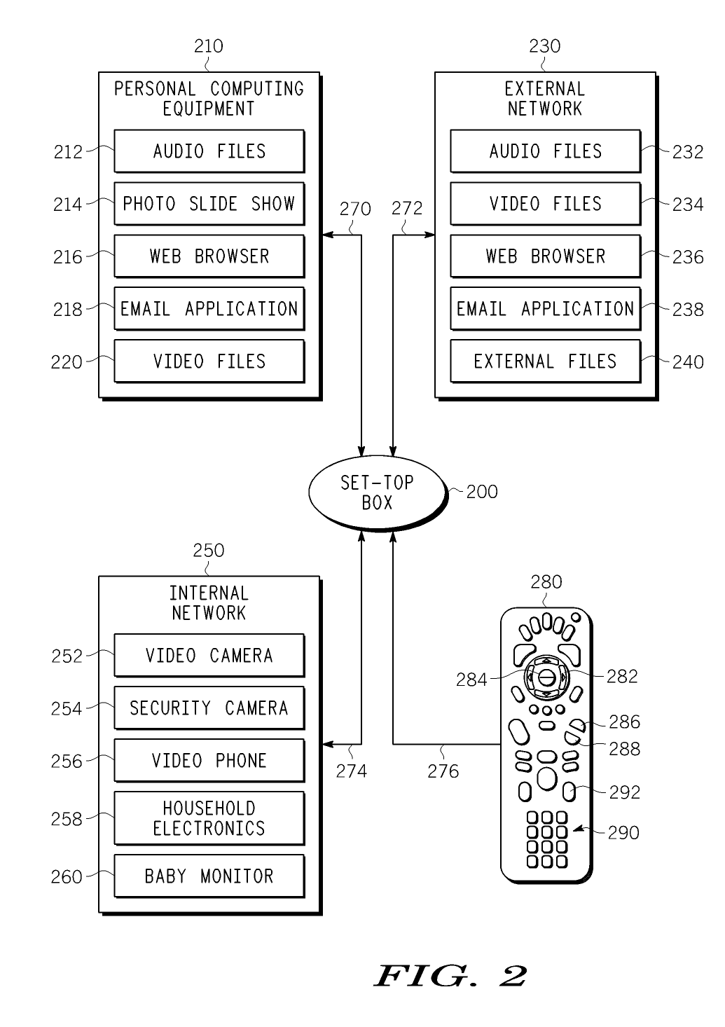

Advanced set-top boxes have rich functionality that allows both internal and external access to data and systems. FIG. 2 shows an alternative representation of potential connections and functionalities of a set-top box (200). In this representation, the components and data sources have been categorized as either personal computing equipment (210), devices associated with an external network (230), or devices associated with an internal network (250). This graphical representation is not intended to be comprehensive, but to illustrate one subset of possible set-top box (200) functionality and interconnectivity.

Personal computing equipment (210) can contain a variety of data that can be displayed on an integrated audio/visual system by accessing and routing the data through the set-top box (200). For example, personal computing equipment may contain audio files (212), photographs that could be organized into a slide show (214), a web browser (216) with supporting Internet connections, an email application (218) and/or video files (220). As discussed above, the connection (270) between the set-top box (200) and the personal computing equipment (210) could take a variety of forms, including but not limited to, Ethernet, USB, or wireless connections.

The set-top box (200) could also connect to internal network sources, such as a video camera (252), one or more security cameras (254) such as a front door camera, a video phone (256), household electronics (258), or a baby monitor (260). The set-top box (200) can be configured to display or output visual and audio data from these sources, thereby increasing the convenience and efficiency of the household. The efficiency is increased because the image is displayed and/or recorded through an existing electronic system, rather then requiring additional electronics to be purchased. The convenience of displaying visual and audio data through the set-top box (200) includes allowing the user to switch rapidly from one viewing source to another. For example, if the user is viewing a program that is streaming live through the set-top box and the door bell rings, the user can switch from viewing the programming to viewing the front door video camera. The set-top box can be configured to automatically remember the time the user stopped viewing the program, start recording the program for later playback and begin to display the front door video camera data. The user can then answer the door if he desires to interact with the person displayed on the screen without missing portions of the program the user had been viewing.

The set-top box (200) can also access an external network (230) to retrieve stored data or connect to real time streaming data. By way of example and not limitation, this data might include audio files (232), video files (234), a web browser (236), an email application (238), or other external files (240).

The typical user interface device with a set-top box (200) is a remote control unit or “remote” (280). The remote (280) has a number of advantages over other input devices, including its small size, mobility, low mass and ability to translate tactile input into commands that are compatible with the set-top box. The remote control can have a variety of tactile controls (282) including buttons, toggles, knobs, joy sticks, rotating disks, and the like. In one exemplary embodiment, the remote (280) has a plurality of directional buttons (282) placed around the circumference of a circle, an “OK/Select” button (284) at the center of the circle, a numeric keypad (290) and a plurality of buttons controlling specific and/or commonly used functions (292). In addition to other tactile controls, the remote also contains “channel plus” (286) and “channel minus” (288) buttons.

As noted above, to access the rich functionality of a set-top box, the manufacturer or service provider typically generates a series of hierarchal menus that allow the user to make selections that bring the user progressively closer to the desired functionality. These menu-driven user interfaces can be overly complicated and lacking in continuity, especially for advanced products or unsophisticated users. For a beginning user, who is becoming accustomed to the functions and features of a set-top box, the menus provide a visual display of available options and allow the beginning user to select from those available options. Typically the menu interface is a hierarchical structure requiring the user to navigate through successive menus to reach a desired function or result. As discussed above, this method of accessing functionality can be cumbersome and time consuming even for experienced users who know exactly which functionality they wish to access.

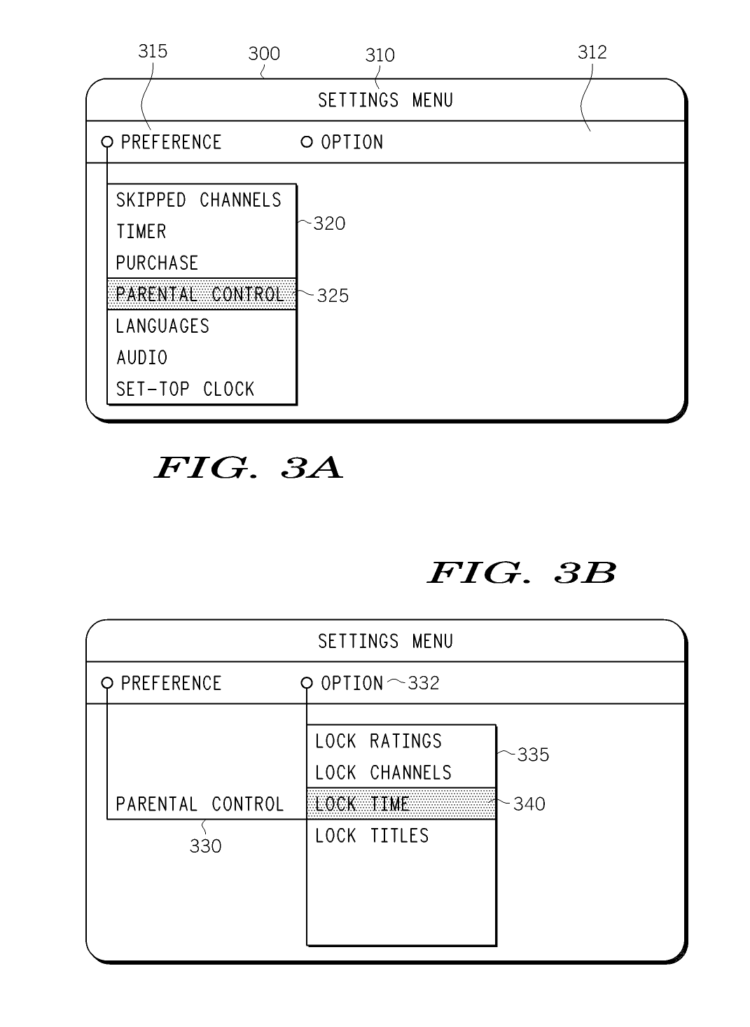

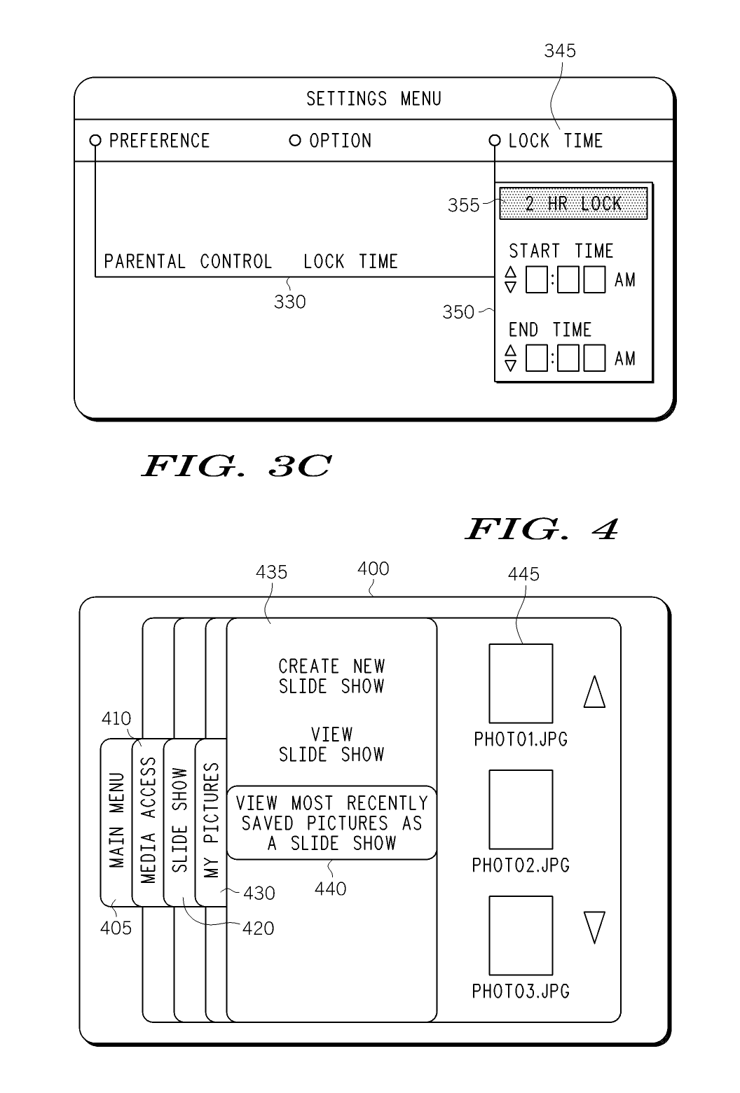

FIGS. 3A-3C illustrate one example of navigating through a series of menus to access a specific functionality of a set-top box. FIG. 3A shows a graphical display (300) of a settings panel (310) which consists of a menu bar (312) with several drop down menus positioned beneath titles, such as the title “Preference” (315). Suppose that a user wants to activate a two hour lock out period that would prevent the use of the set-top box for the next two hours. This two hour lock out period could be during a meal, study time, to restrict viewing of specific programming or be used as a disciplinary method.

To access this particular function, the user would have to first access the settings menu (310), which itself may be submenu of a main menu. Then the user would scroll down through the options of the drop down menu (320) until the desired option was highlighted. In this case, the “Parental Control” option (325) is highlighted. The user then presses the “OK/Select” button (284, FIG. 2) to accept the highlighted selection (325). Typically, a personal identification number (PIN) or other security feature might be entered to access the parental control functions. Entering a PIN would typically be accomplished by pressing the appropriate numeric keys (290, FIG. 2) and then pressing the “OK/Select” button (284, FIG. 2).

The drop down menu (335) is now displayed under the “Option” title (335). A command history (330) graphically conveys the chain of commands that the user has entered up to this point. The user then scrolls down through the possible selections in the options drop down menu (335) until the desired option is highlighted. In this case, the “Lock Time” option (340) is highlighted. The user then presses the “OK/Select” button (284, FIG. 2) to accept the highlighted selection (340).

The user is now presented with a third drop down menu (350) under yet another menu bar title (345). In this drop down menu (350), the user is asked to select either a two hour lock or enter a start and stop time. At this point, the user desires to activate the two hour lock feature (355) which is the first item on the third drop down menu and can simply press the “OK/Select” button (284, FIG. 2).

FIG. 4 illustrates a different graphical approach to navigating through a menu structure. In FIG. 4, the menu structure is presented in a hierarchal tabbed format (400). The user first activates the main menu (405) and scrolls up/down with the directional buttons (282, FIG. 2) to select the desired main menu option. This process is repeated for the next three menus: the “Media Access” menu (410), the “Slide Show” application (420) and the “My Pictures” file structure (430). After navigating through four layers of menus using tens of button strokes, the user is able to activate the desired functionality. In this case, the desired set-top box function is a slide show which displays the most recently saved pictures (440). After this option is highlighted and selected, the set-top box will display the desired photographs (445) from the external storage source as a slide show.

The menu driven approach is a valuable method of presenting information about the menu tree and set-top box functionality. However, after a user is familiar with the set-top box functions and knows exactly which functions he/she desires to use, the menu driven approach to activating set-top box functionality becomes cumbersome and annoying. For example, if the user is watching a movie and the door bell rings, it can be understandably annoying for the user to struggle through a plurality of menus to instruct the set-top box to display the front door video camera feed.

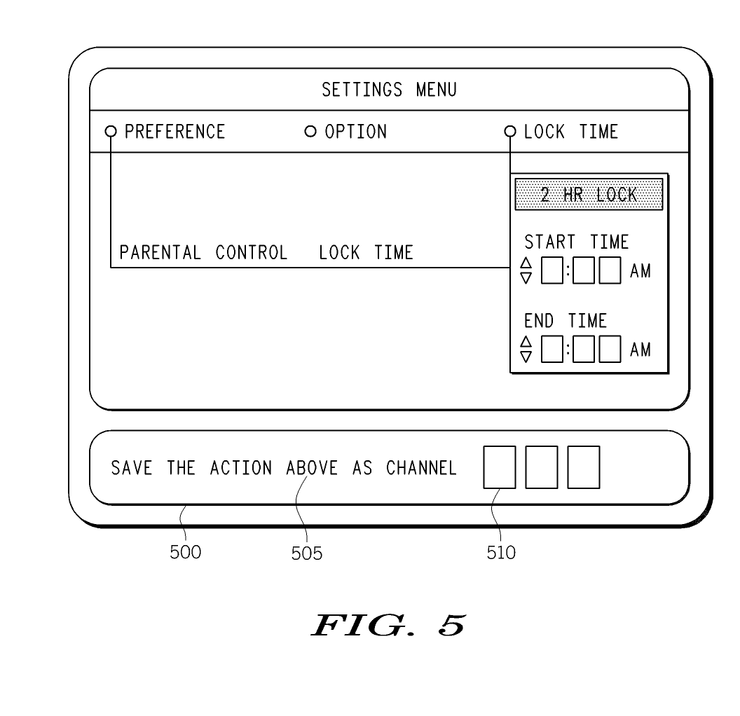

To more efficiently access frequently used functions of the set-top box, specific functionality within the set-top box can be assigned a channel number. FIG. 5 shows the final menu screen of the two hour lock out menu (FIG. 3C). A pseudo channel menu box (500) has been added to the bottom of the display. Text (505) instructs the user to enter a channel identifier or number to associate with the chain of commands that led to the activation of the function above. The user can input a desired channel number in the three boxes (510). For example the user might enter the numbers “9”, “1”, “1” in the respective boxes.

Thereafter, if the user desires to activate a two hour lock out of the set-top box, the user can simply press the numbers “911” on the numeric key pad (290, FIG. 2) as if tuning to a channel numbered “911” to access the two hour lock out function of the set-top box. Alternatively, the user could consult a channel guide which lists the pseudo channels that the user has created and their associated functions. In another exemplary embodiment, the user could activate the two hour lock out feature by flipping through the channels until channel “911” is displayed, and press “OK/Select” to activate the two hour lockout. Flipping through the channels could be accomplished using a variety of methods including pressing the “channel plus” (286, FIG. 2) or “channel minus” (288, FIG. 2) buttons until channel “911” is reached or selecting channel “911” from an on-screen electronic programming guide (EPG) or the like. Additionally, for interfaces that support voice commands, the pseudo channel could be activated by a verbal instruction.

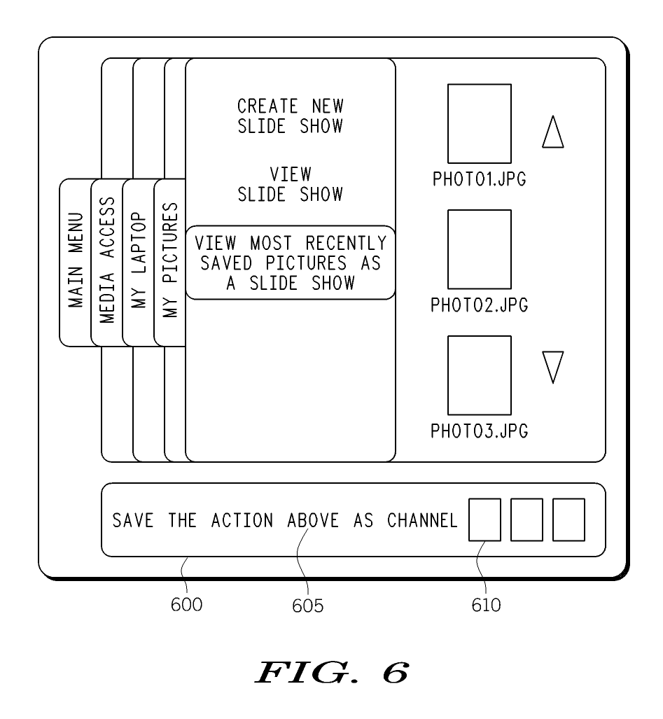

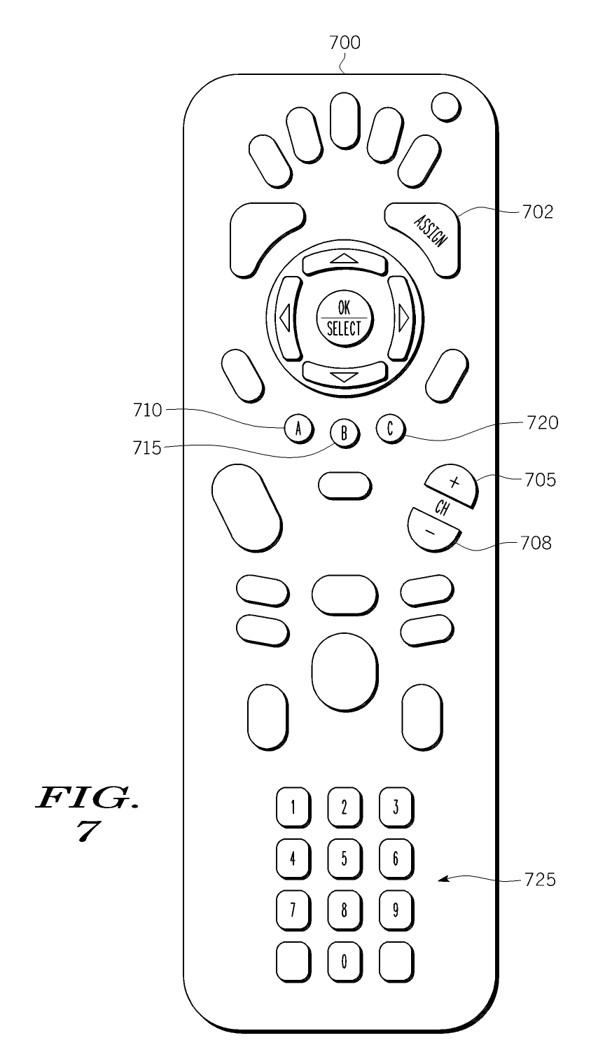

FIG. 6 shows a similar menu item (600) that allows the user to create a personal or pseudo channel that activates the “View most recently saved pictures as a slideshow” function of the set-top box. In one exemplary embodiment, the pseudo channel menu bar (500, 600) could be automatically displayed at the terminal or actionable end of any set of menu commands. According to another exemplary embodiment, the pseudo channel menu bar (500, 600) could be displayed after the user has accessed the specific functionality a given number of times. For example, after the user has accessed a specific functionality three or more times, the set-top box could insert the pseudo channel menu bar at the bottom of the menu display to allow the user the option of creating a pseudo channel.

The specific function activated by entering a pseudo channel is not limited to changing the data source or switching to a new application. The function may also be used to bring the user to a specific point within a menu tree or to perform another navigational function. After arriving at a specific point within a menu tree by entering a pseudo channel identifier, the user can make a selection from the conventional menu options displayed or take other desired action.

Further, the pseudo channels and their associated functions could be manipulated the same way as service provider channels. By way of example and not limitation, pseudo channels could be manipulated using channel changing, display in guide, favorite lineup (assigning favorites), parental rating, and Picture in Picture (PIP) functionality.

FIG. 7 illustrates an alternative method of activating a menu or other functionality that associates a specific function or series of commands with a channel. In this embodiment, the remote has an “Assign” button (702) in addition to other buttons that may be present on the remote. Following a series of commands or menu selections that activate a specific function of the set-top box, the “Assign” button (702) could be pushed. According to one exemplary embodiment, pushing the “Assign” button (702) would activate a pop up menu similar to a pseudo channel menu (500, 600). The pop-up menu could then prompt the user to enter a channel number to create a pseudo channel for the series of commands or menu selections. In another exemplary embodiment, after pressing the “Assign” button (702), the user would simply enter a channel number and the function would be assigned that pseudo channel. Alternatively, the set-top box could automatically assign an unused channel number to the specific function when the “Assign” button (702) is pressed.

In another exemplary embodiment, the service provider could have a selected number of preset pseudo channels that have specific functionality. For example, the service provider could set channel “999” to display diagnostic and billing information. If the customer had questions or problems with the service or set-top box, the service provider could direct the user to press channel “999” for up to date information regarding the users' equipment and service.

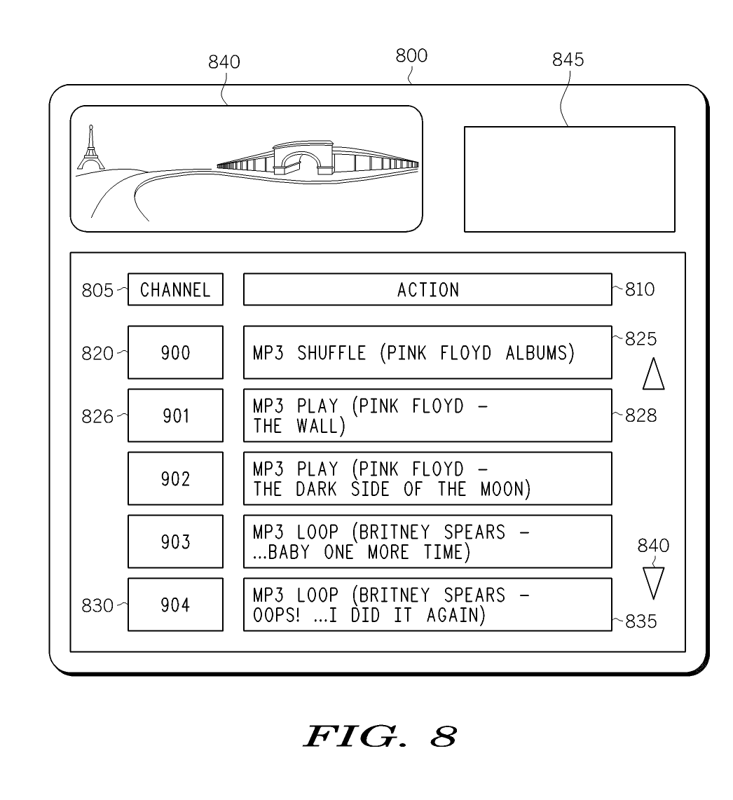

FIG. 8 is an illustrative diagram of a plurality of pseudo channels displayed and organized within a channel guide (800). This technique leverages the existing functionality of the set-top box which is specifically configured to retrieve and display electronic channel guides. The pseudo channels could be organized and displayed in a variety of formats that allow the user to see which channel number is associated with a given functionality of the set-top box. By way of example and not limitation, the pseudo channels could be organized by numeric sequence, by usage, or grouped according to various categories of functionality. The additional pseudo channels could potentially be displayed without altering the hardware, firmware, or conflicting with existing or future channels.

One approach involves using a passive television channel to make the channel guide information available. Another approach involves using an interactive television program guide to access the channel information. In one exemplary embodiment, the set-top software or firmware seamlessly displays the pseudo channels in the same format as the other programming channels. As described below, for pseudo channel listings, the associated functionality replaces the program title and scheduling information.

As shown in FIG. 8, the pseudo channels are listed in numerical order under the “Channel” heading (805) while the associated action for each pseudo channel is displayed to the right of the channel number under the “Action” heading (810). For example, the pseudo channel “900” (820) is listed below the “Channel” heading (805). The action associated with channel “900” directs the set-top box to use an “MP3 Shuffle” function to access and play music files in the folder “Pink Floyd Albums.” By way of example and not limitation, music data may be hosted on the set-top box, external storage, on a media device that is in communication with the set-top box, accessible through the Internet or through satellite radio service.

Similarly, the pseudo channel “901” (826) is listed below the pseudo channel “900” (820). The action associated with channel “901” directs the set-top box to use an “MP3 Play” function to play all music files in the folder “Pink Floyd—The Wall.”

Arrow icons (840) could be used to scroll through the pseudo or real channels displayed on the channel guide (800). Alternatively, the user could scroll through the channel guide (800) by using the channel up and channel down buttons (705, 708; FIG. 7) on the remote control (700, FIG. 7).

The channel guide (800) could also display information related to the user, the channels or data. For example, a graphical display (840) could display an advertisement, a clip from a related music video, album covers of a specific artist, a trailer from an upcoming film or other information. A text box (845) could give additional information regarding the channel or action, such as the location of the file to be accessed, the play time of the files, artist biographies or other information.

Additionally, the channel guide (800) could be used to receive additional user input, such as assigning functions to additional pseudo channels or modifying/deleting previous associations. For example, if a function associated with a particular pseudo channel is no longer desirable, the association could be modified or removed. For example, if a user regularly uses pseudo channels (820, 826) that are associated with the artist “Pink Floyd”, but rarely uses pseudo channels associated with other artists (830), the association between pseudo channel “904” (830) and the “MP3 Loop” functionality (835) could be removed. Users may desire to alter the association of pseudo channels for a variety of reasons. For example, the association may be outdated, placed there by a previous user, the current user's tastes may have changed or the association may be a mistaken entry. The channel guide could have additional functionality (not shown) such as a “Delete” or “Reassign” menu option that allows for additional management of the pseudo channels. Alternatively, the pseudo channel (830) could be simply reassigned to a new function, thereby overwriting and eliminating the prior association.

To avoid conflicts between various users of the set-top box, the pseudo channel settings and associations could be linked to a specific user profile. Following a process in which the current user logs in or identifies themselves through other means, the set-top box could load the pseudo channel settings and associations created by that user.

In the event that the typical channel numbers 1-999 were already in use by the service provider and/or to avoid conflicts with future programming, an alternative channel designating format could be used. By way of example and not limitation, the remote could have an “A” button (710, FIG. 7), “B” button (715, FIG. 7) and/or a “C” button (720, FIG. 7). The pseudo channels could be designated with a combination of alpha and numeric symbols. For example, the pseudo channels could be designated as “A1,” “A2,” “A3” and so forth.

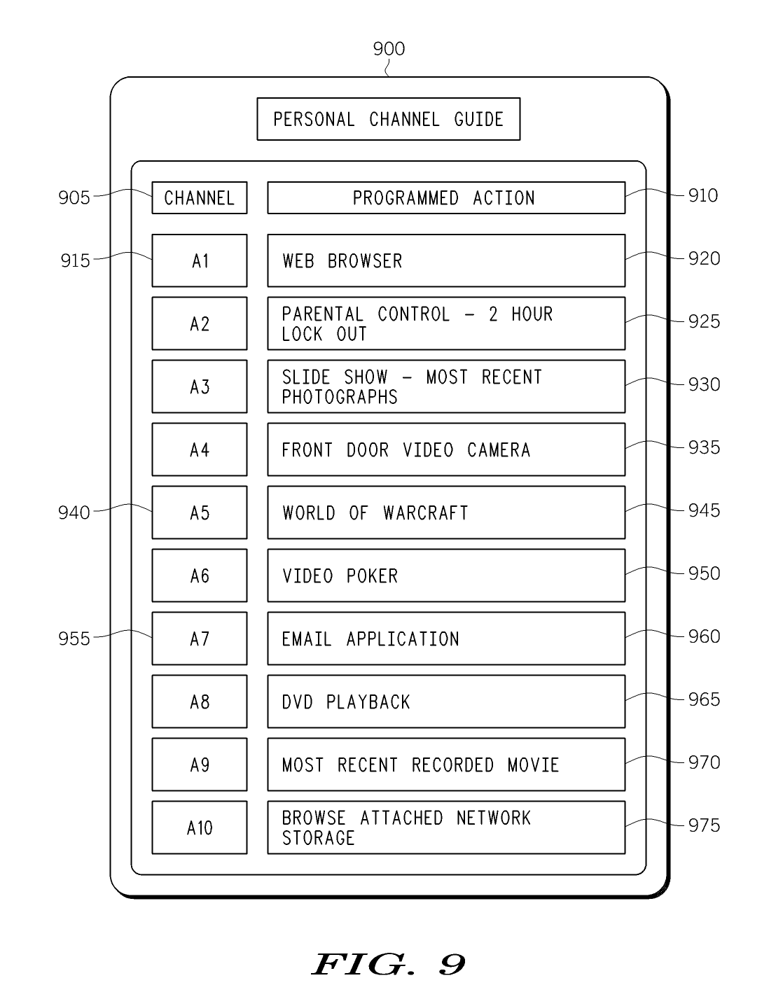

FIG. 9 shows an alternative embodiment of a channel guide (900). Similar to the guide illustrated in FIG. 8, the pseudo channel information is displayed beneath titles (905, 910) in alphanumeric order by channel identifier. In this figure, the channels are represented and activated by pressing an alphanumeric combination, such as the channel “A1” (915). This avoids any possible conflict between the channels distributed by the service provider and the pseudo channels. Although the channel is represented as “A1” both on the channel guide and when it is entered on the remote, the set-top box could translate the “A1” input into an unsigned integer representation that could be compatible with present channel display software or firmware. For example, pseudo channel “A1” could be translated into the integer “10001.” By translating the pseudo channel labels into a higher integer range, conflicts with the current and foreseeable expansion of service provider channels could be avoided. Further, the alpha numeric identifier can be entered by the user with fewer key strokes and may prevent user confusion between regular channels and pseudo channels.

The programmed action that is associated with the pseudo channel “A1” (915) is labeled “Web Browser” (920). According to one exemplary embodiment, entering “A1” on a remote control (700, FIG. 7) would prompt the set-top box to put current activity on hold, begin recording any live programming that might be missed, connect to the Internet, load a web browser and display the web browser/home page on the television screen. Similarly the command “A5” (940) would prompt the set-top box to put current activity on hold, begin recording any live programming that might be missed, connect to the Internet, and access the World of Warcraft logon page. Other programmed actions such as “most recent recorded movie” (970) and “DVD playback” (965) activate functionality within the set-top box itself.

The execution of the function designated by the entry of a pseudo channel could occur in the service provider software or in the manufacturer firmware. In one exemplary embodiment, the entry of a pseudo channel identifier would be received, interpreted, and executed by the firmware. This allows pseudo channels to be used to access user specified functionality with minimum latency and without requiring the service provider software to be modified. Additionally, the firmware could be configured to organize and display the pseudo channels in a channel guide format.

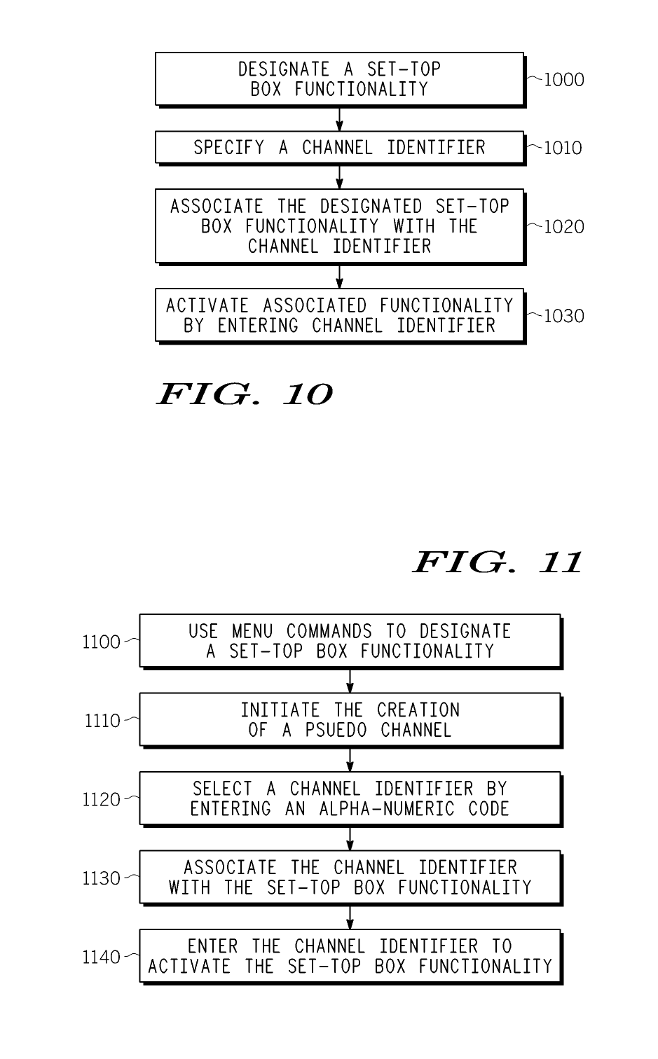

FIG. 10 is a flow chart that shows one illustrative method for programming and executing a pseudo channel. First, a set-top box function is specifically identified (step 1000). Identifying the set-top box function may occur through a variety of means. The function may be selected through a listing, by menu navigation, or by any other means. Next, a channel identifier, such as a numeric or alphanumeric identifier, is specified (step 1010). As mentioned above the channel identifier may be specified through entering a channel identifier in a menu, pressing buttons on the remote or may be assigned by default. The set-top box functionality is then associated with the channel identifier (step 1020). This can occur by pressing a button on the remote such as an “OK/Select” or an “Assign” button, navigating through a menu or by default. Then, to activate the associated functionality, the channel identifier is entered (step 1030).

FIG. 11 is an illustrative flow chart showing one embodiment of a method for configuring and using pseudo channels to activate specific set-top box functionality. According to this exemplary method, menu commands are used to designate a set-top box function (step 1100). The creation of a pseudo channel is initiated by pushing a button on a remote, navigating through a menu or by other means (step 1110). A channel identifier is selected by entering a code comprising of numeric or alphanumeric symbols (step 1120). The channel identifier is then associated with the set-top box function (step 1130). In some cases, the process of designating a channel identifier and associating the channel identifier with specific set-top box functionality can occur simultaneously, as described in FIGS. 5 and 6. To activate the functionality associated with the pseudo channel, the channel identifier can be entered and transmitted to the set-top box (step 1140).

By associating channels with specific set-top box functions, the menu interface can be bypassed by entering a channel identifier. This allows commonly used set-top box functions to be quickly and easily accessed. This unifying user interface leverages the strengths of the set-top box equipment and software/firmware in organizing, displaying, and accessing channels.

Additionally, manipulating channels is a common and familiar interface for most users. By creating a unifying user interface that allows access to frequently activated functionality through pseudo channels, the use of a set-top box becomes easier and more efficient. A pseudo channel allows the user to create a customized and memorable identifier that would serve as an easily remembered shortcut to a specific set-top box function.

For example, users who lack the practice, dexterity or patience to operate a menu driven interface, such as children or the elderly, could change channels until they reach a pseudo channel that activates the desired function.

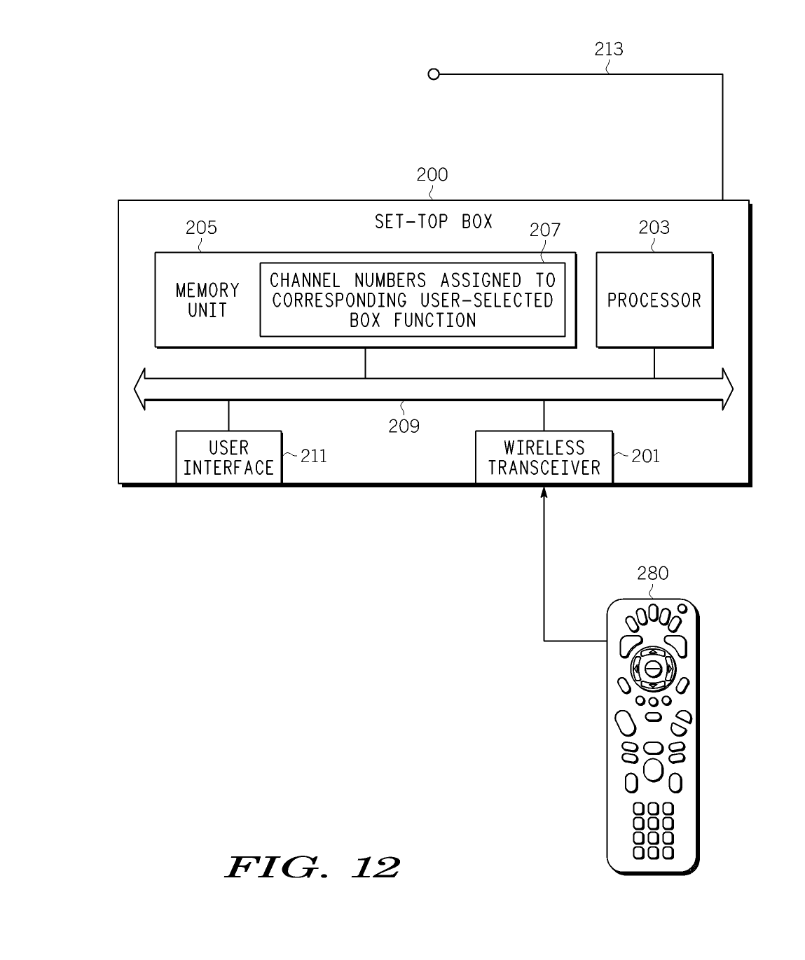

FIG. 12 is an illustrative block diagram of a set-top box, according to principles described herein. As shown in FIG. 12, and consistent with the foregoing description, a typical set-top box (200) will receive an input (213) from any of one or more different sources. Some of these sources were illustrated above by way of example in FIG. 1 and the corresponding text. The set-top box (200) processes the input(s) (213) for output to a playback device (not shown) such as a television or monitor.

Within the set-top box (200), a processor (203) is programmed to control the various components of the box (200) and provide the various functions to be provided by the set-top box (200). The processor (203) may include, for example, a graphics card for producing an electronic program guide layout and hierarchical function menus, as described above, to be output to a display device in communication with the set-top box (200). Set-top box (200) may also include one or more tuners, demodulators and decryptors for processing received content (not shown).

A memory unit (205) may store the programming and data used by the processor (203). The memory unit (205) may contain both volatile and non-volatile memory components.

As described above, a remote control unit (280) may be used to allow a user to control the set-top box (200) through a corresponding wireless transceiver (201). Additionally, there may be a user interface (211) that exists on the box (200) itself. This user interface (211) may include, by way of example, various buttons, a display or any other user input devices useful for controlling the set-top box (200). A data bus (209) may be used to for communication between the various components of the set-top box (200).

As described above, a set-top box under the principles described herein allows a user to create an association between a channel identifier, such as a pseudo channel number, and a particular function of the set-top box. These associations (207) are stored in the memory unit (205). Consequently, when a channel identifier is input to the set-top box (200) using the remote control unit (280) or other user interface (211), the processor (203) will determine whether that channel identifier has been associated with a particular set-top box function in the listing (207) stored in the box memory (205).

If the input channel identifier is associated with a particular set-top box function in the listing (207), that set-top box function is executed in response to input of the channel identifier. If, however, the channel identifier is not included in the listing (207), the channel identifier represents a channel the user desired to the box (200) to tune. Consequently, the set-top box (200) then tunes and outputs the indicated channel from the composite signal received from source (213).

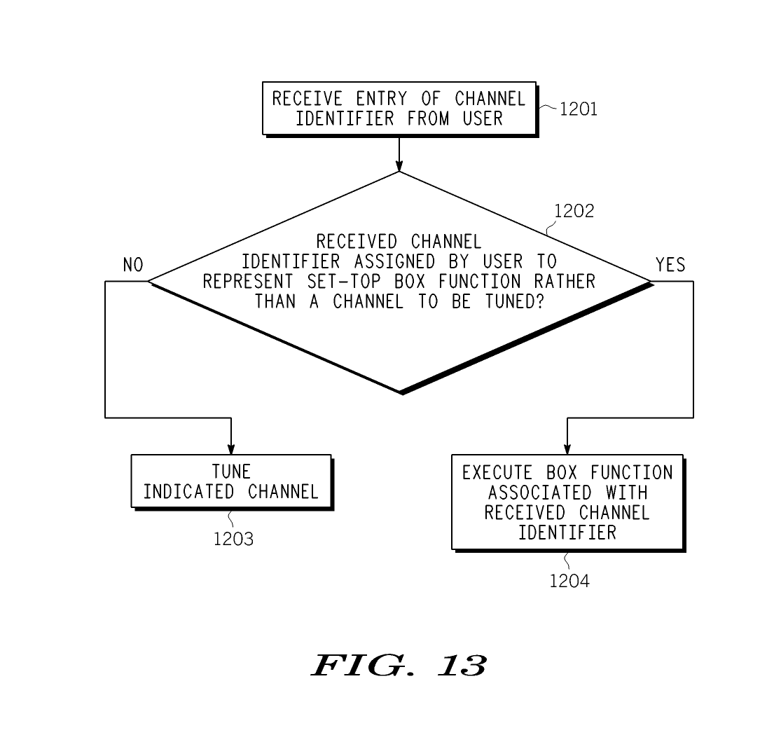

This process is outlined in FIG. 13. FIG. 13 is an illustrative flow chart showing one embodiment of a method of activating set-top box functions with a pseudo channel identifier, according to principles described herein.

As shown in FIG. 13, the process begins when the user inputs a channel identifier (step 1201) to the set-top box. As noted above, the set-top box then determines whether the received channel identifier has been assigned by the user to represent a particular set-top box function, rather than a channel to be tuned (determination 1202).

If the input channel identifier represents a channel to be tuned (determination 1202, NO), then the designated channel is turned by the set-top box (step 1203) and output by the set-top box. If, however, the input channel identifier does corresponding to a designated set-top box function (determination 1202, YES), then the set-top box executes that box function in response to receipt of the input channel identifier (step 1204).

The processes shown in FIGS. 10, 11 and 13, and described throughout the foregoing specification, may be implemented in a general, multi-purpose or single purpose processor. Such a processor will execute instructions, either at the assembly, compiled or machine-level, to perform that process. Those instructions can be written by one of ordinary skill in the art following the description of FIG. 10, 11 or 13 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

The preceding description as been presented only to illustrate and describe embodiments and examples of the principles described. This description is not intended to be exhaustive or to limit these principles to any precise form disclosed. Many modifications and variations are possible in light of the above teaching.

What is claimed is:

1. A user interface for a set-top box comprising:
a set-top box having a plurality of functions available for selection by a user; and
at least one pseudo channel corresponding to at least one of said functions rather than a channel of television programming;
wherein selection of said pseudo channel by a channel identifier initiates said corresponding at least one function of said set-top box.

2. The interface of claim 1, wherein said pseudo channels are indexed in a channel guide.

3. The interface of claim 2, wherein said selection of said pseudo channel is selection of said pseudo channel from a listing in said channel guide.

4. The interface of claim 1, further comprising a remote control unit for selection of said pseudo channel.

5. The interface of claim 1, further comprising a hierarchy of menus listing said functions, said hierarchy of menus comprising a user input device for assigning a pseudo channel identifier to a said function or series of functions.

6. The interface of claim 1, wherein a correspondence between a said pseudo channel and function or functions of said set-top box is configurable by an end user.

7. The interface of claim 1, wherein a correspondence between a said pseudo channel and function or functions of said set-top box is designated by a service provider or manufacturer of said set-top box.

8. The interface of claim 1, further comprising a listing of pseudo channels by channel identifier stored a memory unit of said set-top box.

9. The interface of claim 8, wherein said set-top box, upon input by a user of a channel identifier through said interface, is configured to determine whether said input channel identifier designates a said pseudo channel.

10. A method of creating a pseudo channel comprising:
designating a set-top box function;
providing a channel identifier;
associating said set-top box function with said channel identifier such than when said channel identifier is entered, said set-top box function is actuated.

11. The method of claim 10, wherein said providing a channel identifier further comprises entering a sequence of alpha numeric designators.

12. The method of claim 10, wherein said designating a specific set-top box function comprises navigating through a menu tree.

13. The method of claim 10, wherein said associating said set-top box function with said channel identifier comprises pressing a specialized button on a remote control unit.

14. The method of claim 10, wherein said designating a set-top box function comprises navigating through a hierarchy of menus to locate a listing for said function.

15. The method of claim 10, wherein said associating said set-top box function with said channel identifier further comprises entering a keystroke or series of keystrokes on said remote control unit.

16. The method of claim 10, wherein associating said set-top box function with said channel identifier comprises:
making a series of command selections terminating in the execution of a desired function;
activating an assign option;
providing an alphanumeric channel identifier; and
associating said series of command selections with said channel identifier.

17. The method of claim 16, further comprising entering said channel identifier to activate said desired function.

18. The method of claim 17, wherein said step of entering a channel identifier further comprises moving sequentially through a series of channels selections until said channel identifier is reached.

19. The method of claim 10, further comprising storing a listing of set-top box functions that have been associated with a said channel identifier.

20. The method of claim 19, further comprising:
receiving input by a user of a channel identifier;
determining whether said input channel identifier is associated with a set-top box function in said listing; and
executing a corresponding set-top box function if said input channel identifier is included in said listing.
